(19) United States
(12) Patent Application Publication
(10) Pub. No.: US 2004/0152435 A1
(43) Pub. Date: Aug. 5, 2004

(54) Process for reducing the second-order nonlinearity of a frequency transposition device and corresponding device

(75) Inventors: Bruno Pellat, La Terrasse (FR); Sylvie Gellida, Grenoble (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics SA, Montrouge (FR)

(21) Appl. No.: 10/718,493

(22) Filed: Nov. 20, 2003

(30) Foreign Application Priority Data
Nov. 26, 2002 (FR) 0214799

(51) Int. Cl. H04B 1/26

(52) U.S. Cl. 455/199.1

(57) ABSTRACT

A frequency transposition device includes a current switching circuit with two differential pairs of transistors being controlled by a local oscillator signal. In a current switching circuit calibration mode, the local oscillator is rendered inactive and the two pairs of transistors are calibrated in succession by zeroing the ground path current of one of the pairs of transistors not undergoing calibration, and by setting the voltage difference applied to the bases of the transistors of the pair of transistors undergoing calibration. This is done until the output voltage of the frequency transposition device is zeroed to within a predetermined accuracy. The base voltage difference obtained is stored after calibration. In a normal operating mode the local oscillator is rendered active, and the two stored voltage differences are applied to the respective bases of the two differential pairs of transistors.

### FIELD OF THE INVENTION

The present invention relates to frequency transposition, and more particularly, to reducing the second-order nonlinearity of a frequency transposition device or mixer. The present invention advantageously applies to wireless communication systems, and more particularly, to cellular mobile telephones.

### BACKGROUND OF THE INVENTION

In a terminal of a wireless communication system, such as a cellular mobile telephone for example, direct conversion or zero intermediate frequency transposition is an alternative to a superheterodyne architecture. This is particularly well suited to allow very highly integrated architectural approaches for the terminal.

A direct conversion receiver or a zero intermediate frequency receiver (zero-IF receiver) converts the band of the useful signal directly around the zero frequency (baseband). This is done instead of converting it to an intermediate frequency on the order of a few hundred MHz.

Direct conversion radio frequency receivers have a drawback with respect to the second-order nonlinearity of the input stages. Specifically, since after the mixer the band of the useful signal is centered around zero, any undesired signal, whether continuous or low frequency, is therefore a glitch or spurious signal. These spurious signals may arise in particular from the DC offset (or from the modulation of the low-frequency spurious signals) generated by input blocking signals on account of the second-order nonlinearity of the upstream stages.

More precisely, this second-order nonlinearity may arise either from the low noise amplifier (LNA) generally connected after the antenna, or from the mixer. However, any undesired low frequency signal at the output of the low noise amplifier does not present a problem to a first approximation since the mixer will convert it to a high frequency signal. Consequently, the main problem arises from the second-order nonlinearity of the mixer itself.

Most contemporary circuits do not use a specific design for solving the problem of the second-order nonlinearity of the mixer. These circuits generally use algorithms for monitoring these DC spurious signals. However, such algorithms are not easy to develop, and moreover, they are ineffective when the blocking signals do not induce a purely DC spurious signal, as is the case in constant envelope modulation GSM systems. Instead a low-frequency modulated spurious signal is generated, as is the case for non-constant envelope modulation systems, such as WCDMA systems.

Designs have been proposed for addressing this problem of second-order nonlinearity of the mixer. Some of these approaches, developed in particular for constant envelope modulation systems, are based on setting the DC offset of the mixer during production using an adjustable output load. Such an approach is described for example in the article by Alyosha Molnar, titled “A Single Chip Quad Band (850, 900, 1800, 1900 MHz) Direct Conversion GSM/GPRS RF Transceiver With Integrated VCOs And Fractional-N Synthesizer,” ISSCC 2002, session 14.

Another approach referred to as dynamic matching includes switching dynamically the inputs and the outputs so as to have a symmetric mean operation of the mixer while the mixer is operating. Such an approach is described in the article by Edwin Bautista, et al., titled “Improved Mixer IIP2 Through Dynamic Matching,” ISSCC 2000, session 23, wireless building blocks paper WP 23.1.

However, while such an approach is beneficial since it does not require an adjustment during production, it nevertheless has the drawback of requiring very good synchronization of the switching of the inputs and the outputs. This is particularly difficult to achieve since the inputs and the outputs are spaced apart on the layout on account of isolation problems. Moreover, a specific switching clock is necessary with the risk of undesired aliasing within the band of the useful signal.

### SUMMARY OF THE INVENTION

In view of the foregoing background, an object of the present invention is to address the second-order nonlinearity problem of the mixer without requiring an adjustment to the mixer during production.

Another object of the present invention is also to not require a specific algorithm for monitoring the DC offsets induced by the blocking signals.

Yet another object of the present invention is to provide a mixer that is not sensitive to modulated input blocking signals. This is particularly beneficial to receivers incorporated in third generation mobile telephones.

The present invention starts from the observation that the cause of the second-order nonlinearity of a frequency transmission device or mixer is mainly due to the electrical offset in the transistors of the current switching circuit of the mixer. Starting from this observation, the present invention proposes to calibrate this offset in the mixer itself. Stated otherwise, the present invention proposes a process for reducing the second-order nonlinearity of a frequency transposition device comprising a current switching circuit with two differential pairs of transistors controlled by a local oscillator signal.

According to a general characteristic of the invention, the two differential pairs are statically mutually disconnected and dynamically mutually connected. The process may comprises a current switching circuit calibration mode, in which the local oscillator is rendered inactive and each of the two pairs is calibrated in succession by zeroing the ground path current of the pair not undergoing calibration and by setting the voltage difference applied to the bases of the transistors of the pair undergoing calibration until the output voltage of the frequency transposition device (that is, the output voltage of the current switching circuit) is zeroed to within a predetermined accuracy. The base voltage difference thus obtained is stored.

The process furthermore comprises a normal operating mode of the mixer in which the local oscillator is rendered active and the two voltage differences stored respectively on completion of the calibration mode are applied to the bases of the transistors of the two pairs. According to one mode of implementation, in the calibration mode the phase of setting the base voltage difference comprises a detection of the changing of sign of the difference in output voltage.

The voltage difference applied to the bases of the two transistors of a pair is provided by a digital analog converter in response to a digital control word. The phase of setting the base voltage difference comprises, for example, modifying the digital control word and storing the base voltage difference obtained on completion of the calibration, and then storing the corresponding digital control word. Thus, in one mode of implementation of the invention, the digital control word will be modified, for example by a decrement from a maximum value, until the changing of the sign of the output voltage difference is detected.

Another aspect of the present invention is directed to a frequency transposition device comprising a current switching circuit with two differential pairs of transistors controlled by a local oscillator signal. The two differential pairs may be statically mutually disconnected and dynamically mutually connected, and the device may comprises a calibration loop activated on command. The calibration may calibrate each differential pair by setting the voltage difference applied to the bases of the transistors of the pair undergoing calibration until the output voltage of the frequency transposition device is zeroed to within a predetermined accuracy. Storage means may store for each pair the base voltage difference obtained after calibration. Control means may either render the local oscillator inactive and activate the calibration means by zeroing the ground path current of each pair in succession, or render the local oscillator active to deactivate the calibration loop and to apply the two voltage differences stored respectively in the storage means to the bases of the transistors of the two pairs.

According to one embodiment of the invention, the calibration loop may comprise detection means for detecting the changing of the sign of the output voltage difference. The detection means may comprise a comparator whose two inputs are linked to the two differential outputs of the device.

According to one embodiment of the invention, the calibration loop comprises two digital/analog converters respectively connected to the bases of the transistors of the two pairs. Each converter may apply a voltage difference to the bases of the transistors of the corresponding pair in response to a digital control word. Monitoring means may be connected to the output of the detection means for formulating successive control words until a stop signal delivered by the detection means is received.

Additionally, each converter preferably delivers a voltage difference proportional to the absolute temperature (PTAT voltage). The control means may deactivate the calibration loop by deactivating the detection means and the monitoring means. The device according to the invention is advantageously embodied in integrated form.

The invention is also directed to a component of a wireless communication system, for example a cellular mobile telephone, incorporating a frequency transposition device as defined hereinabove.

### BRIEF DESCRIPTION OF THE DRAWINGS

Other advantages and characteristics of the present invention will become apparent on examining the detailed description of nonlimiting embodiments and modes of implementation, and of the appended drawings in which:

FIG. 1 is a block diagram partially illustrating the internal architecture of a cellular mobile telephone according to the present invention;

FIG. 2 is a schematic diagram illustrating in greater detail an embodiment of a frequency transposition device according to the present invention; and

FIGS. 3 to 5 are flow charts illustrating a mode of implementation of the process according to the present invention.

### DETAILED DESCRIPTION OF THE PREFERRED EMBODIMENTS

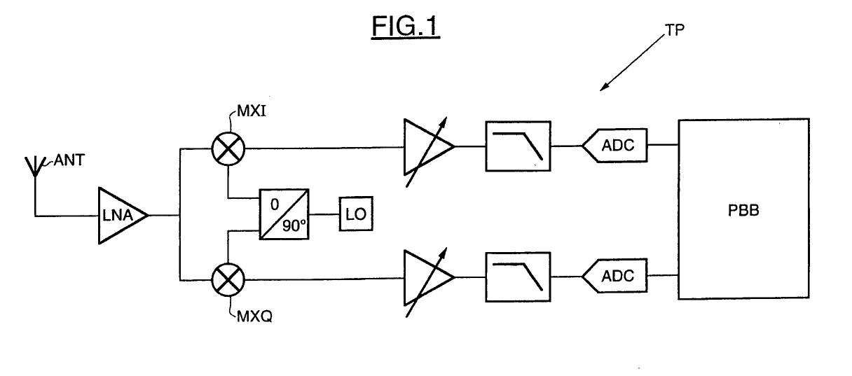

In FIG. 1, the reference TP denotes a cellular mobile telephone incorporating frequency transposition devices or mixers MXI or MXQ according to the present invention. More precisely, the mobile telephone comprises a radio frequency stage connected to a digital stage designed around a processor PBB and analog/digital converters ADC.

The radio frequency stage comprises at the front end an antenna ANT followed by a low noise amplifier LNA connected to the two mixers MXI and MXQ. The two mixers MXI and MXQ belong in a conventional manner to two phase quadrature processing channels, customarily referred to as the I channel and the Q channel by those skilled in the art.

Each mixer MXI and MXQ receives a frequency transposition signal from a local oscillator LO. A 0/90° phase shifter between the local oscillator and the mixers allows delivery to the mixer MXQ of a local oscillator signal phase-shifted by 90° with respect to the local oscillator signal delivered to the mixer MXI. Each of the mixers is followed by a controlled-gain amplifier, and by a low pass filtering stage.

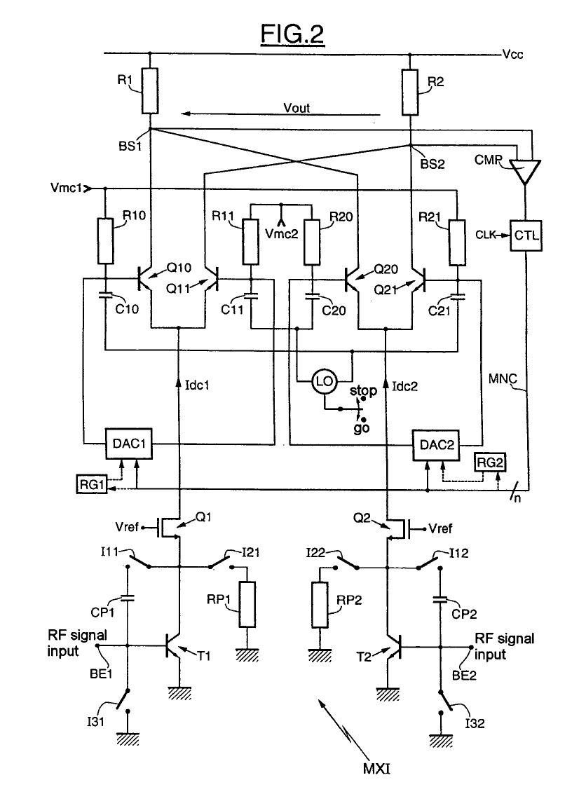

One of the mixers, for example the mixer MXI, will now be described while referring more particularly to FIG. 2. The second mixer MXQ is similar to mixer MXI. The mixer MXI has a differential structure for example and comprises a current switching circuit with two differential pairs of transistors Q10, Q11 and Q20, Q21. The outputs of these transistors are coupled in a crossed manner. More precisely, the collector of the transistor Q10 and the collector of the transistor Q20 are linked together to form a first output terminal BS1. The collector of the transistor Q11 and the collector of the transistor Q21 are linked together to form a second output terminal BS2. These two output terminals form the differential output of the mixer MXI. The resistors R1 and R2 represent the load resistances of the mixer MXI.

The base of the transistor Q10 and the base of the transistor Q21 are linked together by two capacitors C10 and C21 connected in series. Likewise, the base of the transistor Q11 and the base of the transistor Q20 are connected together by two capacitors C11 and C20 connected in series. The midpoint of the two capacitors C10 and C21 as well as the midpoint of two capacitors C11 and C20 are respectively connected to the two terminals of the differential output of the local oscillator LO.

The two bases of the transistors Q11 and Q20 are moreover linked together by two resistors R11 and R20. The same holds for the bases of the transistors Q10 and Q21 which are linked together by way of two resistors R10 and R21. Voltage sources Vmc1 and Vmc2 allow the common mode to be monitored.

Thus, with this arrangement, the two differential pairs are statically mutually disconnected but dynamically mutually connected. That is, they are mutually connected in the presence of a radio frequency signal at the differential input BE1-BE2 of the mixer MXI. In this regard, an input transconductor block is connected between the terminals BE1 and BE2 and the collectors of the transistors of the two differential pairs.

In the described example, which is in no way limiting, the input transconductor block comprises two bipolar transistors T1 and T2 whose emitters are linked to ground and whose respective bases are linked to the terminals BE1 and BE2. These two transistors T1 and T2 are linked to the collectors of the two transistors Q10-Q11 and Q20-Q21 by two cascode arrangements. A voltage source Vref applied to the gates of the transistors Q1 and Q2 sets the static ground path current Idc1 and Idc2 of each of the two differential pairs.

In the described example, a set of two times three breakers I11, I21, I31 and I12, I22 and I32 associated with two capacitors CP1 and CP2, as well as with two resistors RP1 and RP2, make it possible to choose between a low-gain operation or a high-gain operation.

In addition to what has just been described, the mixer comprises a calibration loop formed of a comparator CMP whose two inputs are linked respectively to the two output terminals BS1 and BS2. The output of the comparator CMP is linked to monitoring means CTL regulated by a clock signal CK, and delivers a digital control word MNC (on n bits for example) to two digital/analog converters DAC1 and DAC2.

The differential outputs of the converter DAC1 are linked to the bases of the transistors Q10 and Q11 of the first differential pair, while the differential outputs of the converter DAC2 are linked to the bases of the transistors Q1 and Q21 of the second differential pair. Thus, each converter is capable of applying a voltage difference to the bases of the corresponding transistors as a function of the control word applied to it. This control word defines a code for the converter. Control means, which may be embodied in software within the processor PBB for example, will activate or deactivate the calibration loop and the local oscillator LO.

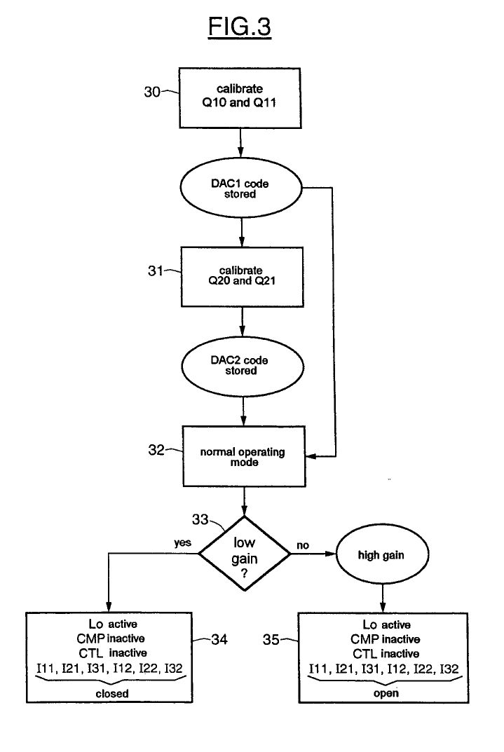

The manner of operation of the mixer according to the invention will now be described in greater detail while referring more particularly to FIG. 3. If we consider the static behavior of the mixer, and more particularly the static behavior of each of the differential pairs taken independently of one another, then the dynamic ground path currents are zero as is the voltage delivered by the local oscillator LO which is stopped. The static current Idc1 of the pair Q10-Q11 for example, is in theory halved by the pair Q10-Q11.

However, on account of the mismatch of the transistors, there is a voltage offset which is manifested at the terminals BS1 and BS2 by a non-zero output voltage Vout equal to (−1+2α); RIdc1 if we assume R=R1=R2. Thus, the DC output voltage Vout is an image of the defective matching α of the transistors Q10-Q11. Likewise, if we consider the pair Q20-Q21 taken in isolation, this voltage Vout is an image of the defective matching of the transistors Q20 and Q21.

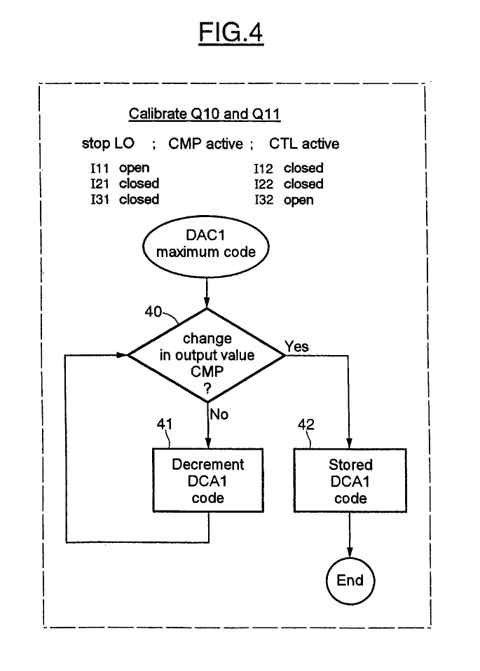

An objective of the calibration loop will then be to zero this voltage Vout for each of the differential pairs taken in isolation. More precisely, as illustrated in FIG. 3, we begin for example with the calibration 30 of the pair of transistors Q10-Q11. This calibration is more particularly illustrated in FIG. 4.

For this calibration, the local oscillator LO is stopped, and the comparator CMP and the monitoring means CTL are activated. The breakers I11, I12 and I22 are open and the other breakers I21, I31 and I32 are closed. The pair Q10 and Q11 is then calibrated, and the static ground path current Idc2 of the pair of transistors Q20 and Q21 is zeroed. This is carried out through the configuration of the breakers.

In the described example, the converter DAC1 is given its maximum code, for example by placing all the bits of the control word at 1. The changing of the output value of the comparator CMP will be detected (step 40). Specifically, as long as the voltage difference Vout is positive, the comparator CMP delivers the value 1 for example, whereas if this voltage difference is negative, the comparator CMP delivers the value 0.

The changing of the output value of the comparator CMP will therefore be characteristic of the zeroing of the voltage Vout to within the accuracy of the converter DAC1. As long as the output value of the comparator CMP is not modified, the monitoring means will decrement (step 41) the control word applied to the converter DAC1. This will have the consequence of modifying the base voltage difference applied to the differential pair of transistors Q10 and Q11.

Upon the changing of the output value of the comparator CMP, the corresponding control word will be stored (step 42), for example in a register RG1. The phase of calibration of the pair of transistors Q10 and Q11 is then terminated.

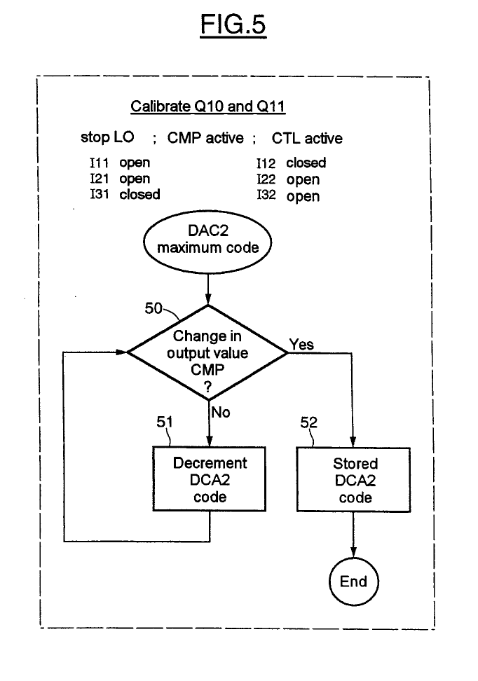

Thereafter one proceeds as illustrated in step 31 of FIG. 3 to calibration of the pair of transistors Q20 and Q21. This calibration is illustrated in greater detail in FIG. 5. Only the differences with FIG. 4 will now be described. For this calibration, the breaker 121 is kept open and the breaker 122 closed. Also, it is now the static ground path current Idc1 which is zeroed. Steps 50, 51 and 52 are similar to steps 40, 41 and 42.

Upon the detection of the changing of the output value of the comparator CMP, the corresponding control word of the converter DAC2 is stored in a register RG2. This marks the end of the calibration phase of the pair Q20-Q21.

Once this calibration mode has been performed, we then go to a normal operating mode (step 32). In the normal operating mode, the converters DAC1 and DAC2 are continuously controlled by the control words obtained on completion of the calibration mode. Consequently, they apply respectively to the corresponding transistor pairs the base voltage differences allowing electrical correction of the defective matching of the transistors of the current switching circuit.

In this normal operating mode, the local oscillator LO is active. On the other hand, the comparator CMP is inactive, as are the monitoring means CTL (clock CK off). In the normal operating mode it is then possible to choose a low-gain mode (step 34) in which all the breakers I11, I21, I31, I12, I22 and I32 are closed, or else a high-gain mode in which all the aforesaid breakers are open.

The calibration will be performed, in the case of a cellular mobile telephone, preferably when the telephone is switched on, and at later instants which will be defined by the baseband processor PBB. This will make it possible in particular to take account of the changing of the temperature which is a parameter that influences the defective matching. In this regard, it will be advantageous to provide converters DAC1 and DAC2 incorporating a voltage source proportional to absolute temperature (PTAT source).

That which is claimed is:

1. Process for reducing the second-order nonlinearity of a frequency transposition device comprising a current switching circuit with two differential pairs of transistors (Q10, Q11, Q20, Q21) controllable by a local oscillator signal (LO), characterized in that the two differential pairs being statically mutually disconnected and dynamically mutually connected, it comprises a current switching circuit calibration mode, in which the local oscillator (LO) is rendered inactive and each of the two pairs is calibrated in succession by zeroing the earth path current (Idc2) of the pair (Q20, Q21) not undergoing calibration and by setting the voltage difference applied to the bases of the transistors of the pair (Q10, Q11) undergoing calibration until the output voltage (Vout) of the frequency transposition device is zeroed to within some accuracy, and the base voltage difference thus obtained is stored, and a normal operating mode in which the local oscillator (LO) is rendered active and the two voltage differences stored respectively on completion of the calibration mode are applied to the bases of the transistors of the two pairs.

2. Process according to Claim 1, characterized in that in the calibration mode the phase of setting of the base voltage difference comprises a detection (CMP) of the changing of sign of the difference in output voltage (Vout).

3. Process according to Claim 1 or 2, characterized in that the voltage difference applied to the bases of the two transistors of a pair is provided by a digital analog converter (DAC1, DAC2) in response to a digital control word, in that the phase of setting of the base voltage difference comprises a modifying of the digital control word, and in that the storing of the base voltage difference finally obtained on completion of the calibration comprises a storing of the corresponding digital control word.

4. Process according to Claim 2 and 3, characterized in that the digital control word (MNC) is modified until the changing of sign of the output voltage difference is detected.

5. Frequency transposition device comprising a current switching circuit with two differential pairs of transistors controllable by a local oscillator signal, characterized in that the two differential pairs (Q10, Q11, Q20, Q21) are statically mutually disconnected and dynamically mutually connected, in that it comprises a calibration loop activatable on command and able to calibrate each differential pair by setting the voltage difference applied to the bases of the transistors of the pair undergoing calibration until the output voltage of the frequency transposition device is zeroed to within some accuracy, storage means (RG1, RG2) able to store for each pair the base voltage difference obtained after calibration, control means (PBB) able either to render the local oscillator inactive and to activate the calibration means by zeroing the earth path current of each pair in succession, or to render the local oscillator active, to deactivate the calibration loop and to apply the two voltage differences stored respectively in the storage means to the bases of the transistors of the two pairs.

6. Process according to Claim 5, characterized in that the calibration loop comprises detection means (CMP) able to detect the changing of sign of the output voltage difference.

7. Device according to Claim 6, characterized in that the detection means comprise a comparator (CMP) whose two inputs are linked to the two differential outputs of the device.

8. Process according to Claim 6 or 7, characterized in that the calibration loop comprises two digital/analog converters (DAC1, DAC2) respectively connected to the bases of the transistors of the two pairs, each converter being able to apply a voltage difference to the bases of the transistors of the corresponding pair in response to a digital control word, and monitoring means (CTL) connected to the output of the detection means and able to formulate successive control words until a stop signal delivered by the detection means is received.

9. Device according to Claim 8, characterized in that each converter (DAC1, DAC2) is able to deliver a voltage difference proportional to the absolute temperature.

10. Device according to Claim 8 or 9, characterized in that the control means (PBB) are able to deactivate the calibration loop by deactivating the detection means and the monitoring means.

11. Device according to one of Claim 5 or 10, characterized in that the bases of the two homologous transistors of each pair are linked by way of two capacitors connected in series, and in that the midpoint of the two capacitors is connected to the local oscillator.

12. Device according to Claim 5 or 11, characterized in that it is embodied in integrated form.

13. Component of a wireless communication system, characterized in that it incorporates a frequency transposition device according to one of claims 5 to 12.

14. Component according to Claim 13, characterized in that it forms a cellular mobile telephone.
